(19) United States
(12) Patent Application Publication
(10) Pub. No.: US 2024/0323344 A1
(43) Pub. Date: Sep. 26, 2024

(54) SYSTEM AND METHOD FOR TESTING IMAGE SIGNAL PROCESSING (ISP) FUNCTIONALITY

(71) Applicant: QUALCOMM INCORPORATED, SAN DIEGO, CA (US)

(72) Inventors: Abhijeet DEY, Bengaluru (IN); Rahul GULATI, San Diego, CA (US); Joby ABRAHAM, Bangalore (IN); Vijayamanohar NAGARAJAN, Bangalore (IN); Aakil Mahendra BAPNA, Bangalore (IN)

(21) Appl. No.: 18/188,863

(22) Filed: Mar. 23, 2023

(51) Int. Cl. H04N 17/00

(52) U.S. Cl. CPC H04N 17/002

(57) ABSTRACT

An image processing system includes an image sensor configured to generate a video frame, the video frame having a data portion and a test portion, an inline front end (IFE) having at least one processing module, a first memory, a functional software register, and a test software register, the IFE configured to receive the video frame, process the video frame and store the processed video frame to a second memory, a test pattern generator configured to generate test data that is provided to the IFE during the test portion of the video frame, a multiple input signature register (MISR) test function configured to compute a MISR signature from the test data, and a comparison function configured to compare a verified version of the test data to the computed MISR signature in the IFE to determine whether a system interrupt should be generated.

### FIELD

The present disclosure relates generally to electronics, and more specifically to testing image signal processing (ISP) functionality.

### BACKGROUND

Driver assistance technology continues to expand in the field of automobiles. For example, assisted driving and self-driving technology relies on a number of different sensors and processing functions to ensure safety. One such sensor and processing function is a camera and its related image signal processing functions. Typically, the image signal processing functions include an image processing system referred to as an inline front-end (IFE) that may include image signal processing (ISP) modules, and related software registers and memory modules connected to the ISP modules. Generally, the memory modules may include static random access memory (SRAM) modules. The ISP modules and related software registers and memory modules may be arranged in a serial architecture where a number of ISM modules (and related software registers and memory modules) are arranged in a serial manner to each process a different aspect of an image signal containing image frames presented to the IFE by one or more image sensors. The output of the serially arranged ISP modules may be provided to a double data rate (DDR) synchronous dynamic random access memory (SDRAM) for storage and further processing.

The IFE may be located on a system on chip (SOC) and the software registers may provide configuration information to the ISP module and the SRAM may store the pixels related to the image processed by the related ISP module.

Typically, in mission mode, the software registers may be protected by what are referred to as “parity” checks to verify the integrity of the software configuration. The SRAM may be protected by what is referred to as an “error correction code” (ECC). However, the ISP module is typically not tested in mission mode, but instead may only be tested during power on using what is referred to as logic built in self-test (LBIST) and/or memory built in self-test (MBIST) functions.

In the past, to verify the operation of the ISP module, it was common to increase the number of image frames per second (FPS) and increase the clock frequency of the IFE to inject test frames at a given rate. For example, if the use case dictates an operating frequency of 30 FPS, the working FPS may be increased to 38 FPS so that in one second, 30 functional frames and 8 test frames are processed by an ISP module. A number of drawbacks exist with this methodology including, for example, an increase in clock frequency (of approximately 12.5% in this example), which leads to significant increase in power consumption for the camera; and an increase of 12.5% in DDR memory power consumption.

Therefore, it would be desirable to have a way to test an ISP module in mission mode that does not include such drawbacks.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an image processing system including an image sensor configured to generate a video frame, the video frame having a data portion and a test portion, an inline front end (IFE) having at least one processing module, a first memory, a functional software register, and a test software register, the IFE configured to receive the video frame, process the video frame and store the processed video frame to a second memory, a test pattern generator configured to generate test data that is provided to the IFE during the test portion of the video frame, a multiple input signature register (MISR) test function configured to compute a MISR signature from the test data, and a comparison function configured to compare a verified version of the test data to the computed MISR signature in the IFE to determine whether a system interrupt should be generated.

Another aspect of the disclosure provides a method for testing an image processing system including configuring a test software register prior to the start of a video frame, generating test image data, generating a verified multiple input signature register (MISR) value corresponding to the test image data, injecting the test data to the IFE during a blanking interval of the video frame, processing the test data to generate a test output, computing a MISR signature associated with the test output; and comparing the computed MISR signature to the verified MISR value to determine whether the test data matches the generated test output.

Another aspect of the disclosure provides a device for testing an image processing system including means for configuring a test software register prior to the start of a video frame, means for generating test image data, means for generating a verified multiple input signature register (MISR) value corresponding to the test image data, means for injecting the test data to the IFE during a blanking interval of the video frame, means for processing the test data to generate a test output, means for computing a MISR signature associated with the test output. and means for comparing the computed MISR signature to the verified MISR value to determine whether the test data matches the generated test output.

Another aspect of the disclosure provides a non-transitory computer-readable medium comprising computer instructions for execution by a processor, the computer instructions including computer instructions executable by the processor for configuring a test software register prior to the start of a video frame, computer instructions executable by the processor for generating test image data, computer instructions executable by the processor for generating a verified multiple input signature register (MISR) value corresponding to the test image data, computer instructions executable by the processor for injecting the test data to the IFE during a blanking interval of the video frame, computer instructions executable by the processor for processing the test data to generate a test output, computer instructions executable by the processor for computing a MISR signature associated with the test output, and computer instructions executable by the processor for comparing the computed MISR signature to the verified MISR value to determine whether the test data matches the generated test output.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a diagram showing an automobile having one or more cameras.

FIG. 2 is a block diagram showing an image processing system in accordance with an exemplary embodiment of the disclosure.

FIG. 3 is a block diagram showing an in line front end (IFE) of FIG. 2 in accordance with an exemplary embodiment of the disclosure.

FIG. 4 is a diagram showing video frames in accordance with an exemplary embodiment of the disclosure.

FIG. 5 is a block diagram showing an in line front end (IFE) of FIG. 2 in accordance with an exemplary embodiment of the disclosure.

FIG. 6 is a diagram showing video frames in accordance with an exemplary embodiment of the disclosure.

FIG. 7 is a diagram showing the MISR test function of FIG. 3 and FIG. 5 in greater detail.

FIG. 8 is a flow chart describing an example of the operation of a method for performing video system testing.

FIG. 9 is a functional block diagram of an apparatus for video system testing.

FIG. 10 is a flow chart describing an example of the operation of a method for performing video system testing.

FIG. 11 is a functional block diagram of an apparatus for video system testing.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In accordance with an exemplary embodiment, a system and method to functionally test one or more processing modules in an in-line front end (IFE) in an image processing system is disclosed.

In accordance with an exemplary embodiment, a system and method to functionally test one or more processing modules in an in-line front end (IFE) in an image processing system may use a blanking interval in a video frame to send test data without consuming video frame resources used for sending data. A blanking interval may be a vertical blanking interval (VBI) or a horizontal blanking interval (HBI) in a video frame.

In accordance with an exemplary embodiment, a system and method to functionally test one or more processing modules in an in-line front end (IFE) in an image processing system may be used in mission-mode to improve an automobile safety integrity level (ASIL) score.

In accordance with an exemplary embodiment, a system and method to functionally test one or more processing modules in an in-line front end (IFE) in an image processing system may be used to verify the integrity of an ISP module in mission mode with no increase in the number of frames per second (FPS), no increase in the system clock rate, and no impact to the bandwidth or power consumption of the system memory.

In accordance with an exemplary embodiment, a number of test frames sent to functionally test one or more processing modules in an in-line front end (IFE) in an image processing system may be adjusted based on a desired ASIL score.

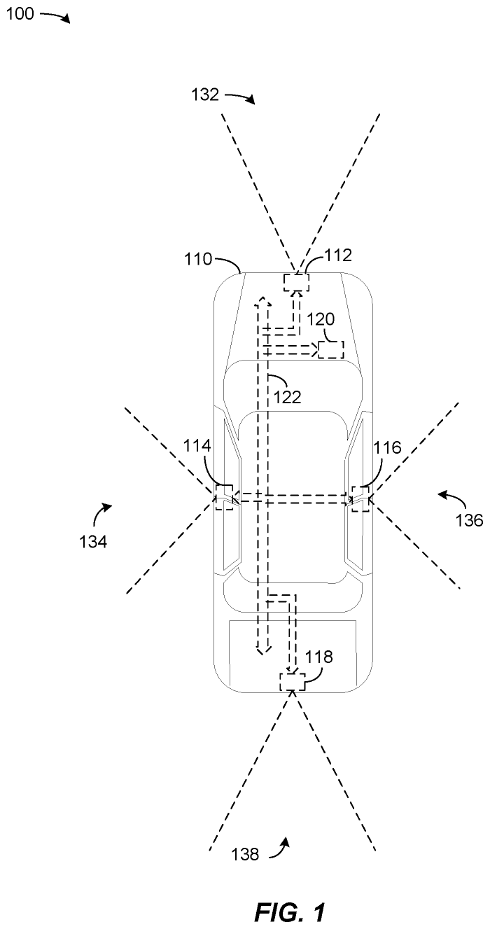

FIG. 1 is a diagram 100 showing an automobile having one or more cameras. In an exemplary embodiment, an automobile 110 may be equipped with one or more cameras and an image processing system. For example, the automobile 110 may comprise a forward facing camera 112, side facing cameras 114 and 116, and a rear facing camera 118. The camera 112 may have a field of view, generally indicated as area 132, the camera 114 may have a field of view, generally indicated as area 134, the camera 116 may have a field of view, generally indicated as area 136, and the camera 118 may have a field of view, generally indicated as area 138. The cameras 112, 114, 116 and 118 may be connected to an image processing system 120 over a communication bus 122. In some embodiments, the cameras 112, 114, 116 and 118 together with the image processing system 120 form a camera system. Although four cameras are depicted in FIG. 1, the automobile 110 may be equipped with more or fewer cameras.

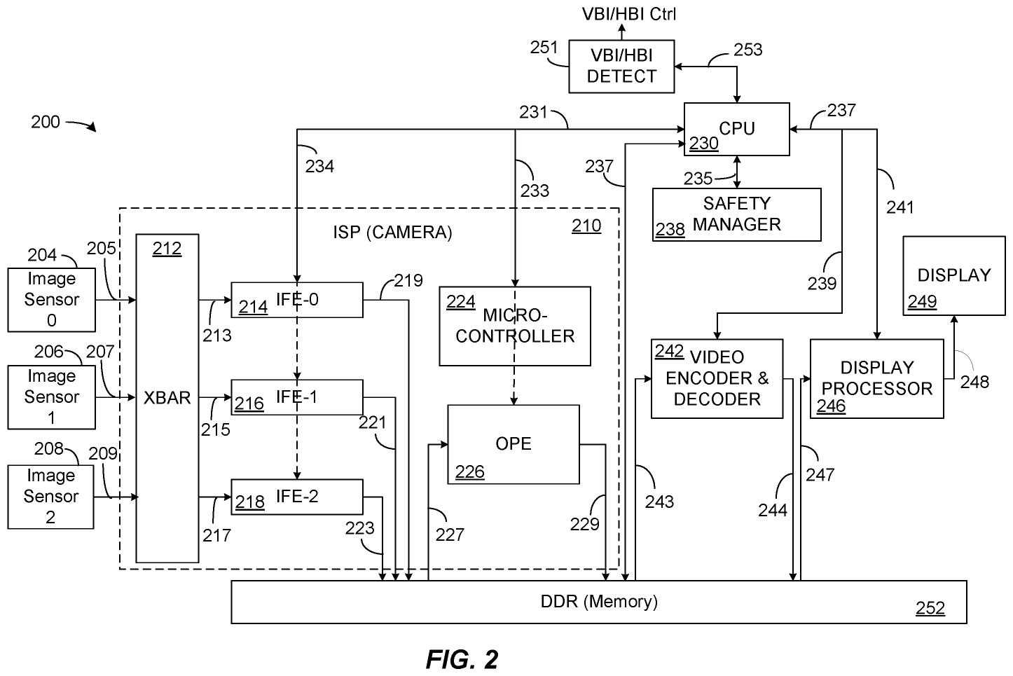

FIG. 2 is a block diagram showing an image processing system 200 in accordance with an exemplary embodiment of the disclosure. In an exemplary embodiment, the image processing system comprises a camera 210 configured to receive image data from one or more image sensors. In an exemplary embodiment, the camera 210 may also be referred to as an image signal processing (ISP) element. In an exemplary embodiment, three image sensors 204, 206 and 208 are shown in FIG. 2 as providing input to the camera 210. In an exemplary embodiment, the image processing system 200 also comprises a central processing unit (CPU) 230, a VBI/HBI detect module 251, a safety manager 238, a video encoder & decoder 242, a display processor 246, a display 249 and a double data rate (DDR) synchronous dynamic random access memory (SDRAM) 252, referred to as DDR memory 252.

In an exemplary embodiment, the camera 210 may comprise a crossbar switch 212, in-line front end (IFE) modules 214, 216 and 218, a micro-controller 224 and an offline processing engine (OPE) 226.

In an exemplary embodiment, the image sensor 204 provides image data (e.g., pixels) over connection 205 to the crossbar switch 212, the image sensor 206 provides image data (e.g., pixels) over connection 207 to the crossbar switch 212, and the image sensor 208 provides image data (e.g., pixels) over connection 209 to the crossbar switch 212. In an exemplary embodiment, the crossbar switch 212 is connected to the IFE 214 over connection 213, is connected to the IFE 216 over connection 215 and is connected to the IFE 218 over connection 217. In an exemplary embodiment, the crossbar switch 212 provides the image data from any of the image sensors 204, 206 and 208 to any of the IFEs 214, 216 and 218.

In an exemplary embodiment, the number of image sensors is the same as the number of IFEs and the image data from the image sensors 204, 206 and 208 will be processed in parallel by the IFEs 214, 216 and 218. However, the number of image sensors shown in FIG. 2 may not be the total number of image sensors in an image processing system.

In an exemplary embodiment, the IFEs 214, 216 and 218 are real-time processing engines configured to process in real-time the image data from the image sensors 204, 206 and 208. In an exemplary embodiment, the IFEs 214, 216 and 218 perform sensor-artifact removal and image format conversion, such as for example, conversion from Bayer format to YUV format, and other processing tasks.

In an exemplary embodiment, an output of the IFE 214 is provided over connection 219 to the DDR memory 252, an output of the IFE 216 is provided over connection 221 to the DDR memory 252, and an output of the IFE 218 is provided over connection 223 to the DDR memory 252.

In an exemplary embodiment, the CPU 230 may be connected to the IFEs 214, 216 and 218 over connection 234, may be connected to the micro-controller 224 and OPE 226 over connection 233, may be connected to the DDR memory 252 over connection 237 and may be connected to the VBI/HBI detect module 251 over connection 253. The CPU 230 provides control information over connection 234 to the IFE 214, IFE 216 and IFE 218, and provides control information over connection 233 to the micro-controller 224 and the OPE 226.

In an exemplary embodiment, the CPU 230 may be connected to the video encoder & decoder 242 over connection 239 and may be connected to a display processor 246 over connection 241. The CPU 230 provides control information over connection 239 to the video encoder & decoder 242 and over connection 241 to the display processor 246.

In an exemplary embodiment, the CPU 230 may be connected to the safety manager 238 over connection 235. In certain circumstances, such as faults in the system, the CPU 230 may cause the safety manager 238 to generate a functional safety interrupt request (e.g., a FUSA IRQ). In an exemplary embodiment, the safety manager 238 may be implemented as a dedicated hardware element, or may be implemented as software executing on the CPU 230.

In an exemplary embodiment, the processed image data from the IFEs 214, 216 and 218 may be provided from the DDR memory 252 to the OPE 226 over connection 227. In an exemplary embodiment, the OPE 226 may have a higher performance level than the IFEs 214, 216 and 218 so that a single OPE may process all images from the three IFEs 214, 216 and 218. The OPE 226 performs noise processing and image enhancement and writes the processed image signals to the DDR memory 252 over connection 229. In an exemplary embodiment, the micro-controller 224 performs the scheduling of the images that are processed by the OPE 226 under the overall control of the CPU 230. Accordingly, the connection between the micro-controller 224 and the OPE 226 is shown using a dashed line.

The video encoder & decoder 242 receives the processed image signals from the OPE 226 over connection 243 via the DDR memory 252 and provides an encoded or decoded video signal over connection 244 to the DDR memory 252. The video encoder & decoder 242 is controlled by the CPU 230 over connection 239.

The display processor 246 receives the output of the video encoder & decoder 242 over connection 247 via the DDR memory 252 and also provides an output over connection 248 to a display 249. The display processor 246 is controlled by the CPU 230 over connection 241.

In some embodiments, the CPU 230 and the DDR memory 252, or other memory associated with the CPU 230, may store and execute compute code configured to perform the steps described herein. For example, the CPU 230 may execute instructions stored on a non-transitory computer-readable medium comprising computer instructions for execution by the CPU 230 for performing the functions described herein.

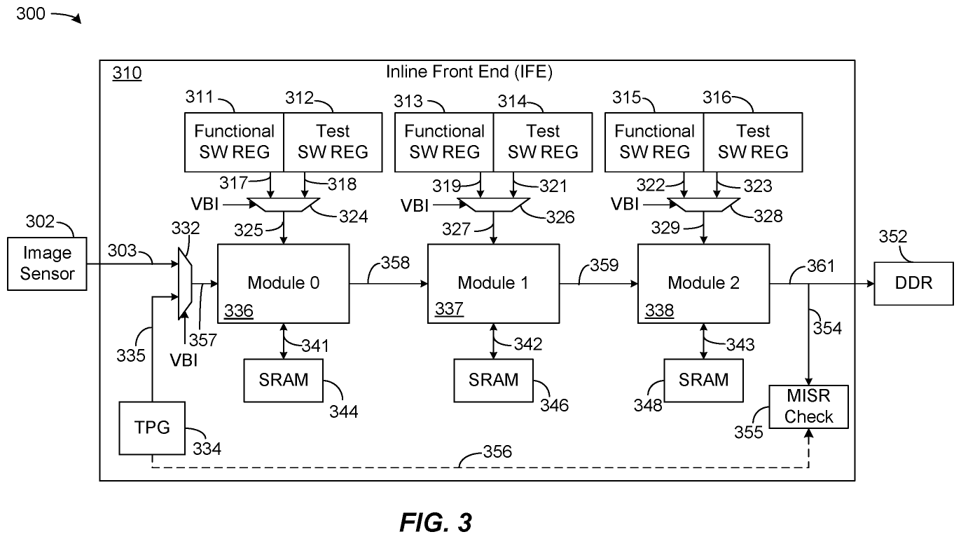

FIG. 3 is a block diagram 300 showing an in-line front end (IFE) 310 of FIG. 2 in accordance with an exemplary embodiment of the disclosure. In an exemplary embodiment, the IFE 310 may be configured to perform processing module testing using test frames sent during the vertical blanking interval (VBI) of a video frame. In an exemplary embodiment, the IFE 310 may receive image data from an image sensor 302. Although a single image sensor 302 is shown in FIG. 3, the IFE 310 may receive image data from more than one image sensor.

In an exemplary embodiment, the IFE 310 comprises processing modules 336, 337 and 338. In an exemplary embodiment, each of the processing modules 336, 337 and 338 may be configured to perform different image processing tasks on the image data from the image sensor 302.

The IFE 310 also comprises a functional software (SW) register (REG) 311 connected to a multiplexer (MUX) 324 over connection 317 and a test SW REG 312 connected to the MUX 324 over connection 318. The MUX 324 is connected to the processing module 336 over connection 325. The MUX 324 is configured to receive a control signal, VBI, from the VBI/HBI detect module 251. In an exemplary embodiment, the VBI control signal may be generated by logic and/or software configured to detect the VBI period in an image stream, this logic being shown in FIG. 2 as VBI/HBI detect module 251. For example, the VBI period may be detected based on the end of a current frame to the start of a next frame. In an exemplary embodiment, the VBI/HBI detect module 251 executing on the CPU 230 of FIG. 2 (or another processor) may detect the VBI period and can generate the VBI control signal when it is desired to configure the processing module 336 using the configuration provided by the test SW REG 312. When the control signal, VBI, is not asserted, the processing module 336 is configured by the functional SW REG 311.

The IFE 310 also comprises a functional SW REG 313 connected to a multiplexer (MUX) 326 over connection 319 and a test SW REG 314 connected to the MUX 326 over connection 321. The MUX 326 is connected to the processing module 337 over connection 327. The MUX 326 is configured to receive the control signal, VBI, when it is desired to configure the processing module 337 using the configuration provided by the test SW REG 314. When the control signal, VBI, is not asserted, the processing module 337 is configured by the functional SW REG 313.

The IFE 310 also comprises a functional SW REG 315 connected to a multiplexer (MUX) 328 over connection 322 and a test SW REG 316 connected to the MUX 328 over connection 323. The MUX 328 is connected to the processing module 338 over connection 329. The MUX 328 is configured to receive the control signal, VBI when it is desired to configure the processing module 338 using the configuration provided by the test SW REG 316. When the control signal, VBI, is not asserted, the processing module 338 is configured by the functional SW REG 315.

In an exemplary embodiment, the processing module 336 is connected to a static random access memory (SRAM) 344 over connection 341; the processing module 337 is connected to a static random access memory (SRAM) 346 over connection 342; and the processing module 338 is connected to a static random access memory (SRAM) 348 over connection 343.

In an exemplary embodiment, image data (pixels) is provided from the image sensor 302 over connection 303 to a MUX 332. The MUX 332 is also connected to a test pattern generator (TPG) 334 over a connection 335. The MUX 332 is also configured to receive the control signal, VBI. When the control signal, VBI, is asserted, the MUX 332 provides an output of the TPG 334 to the processing module 336. When the control signal, VBI, is not asserted, the MUX 332 provides an output of the image sensor 302 to the processing module 336.

In an exemplary embodiment, when in a normal processing mode, image data is provided from the image sensor 302 over connection 303 to the MUX 332 and then over connection 357 to the processing module 336. The processing module 336 performs its image processing function and then provides its output over connection 358 to the processing module 337. The processing module 337 performs its image processing function and then provides its output over connection 359 to the processing module 338. The processing module 338 performs its image processing function and then provides its output over connection 361 to the DDR memory 352.

In an exemplary embodiment, a multiple input signature register (MISR) test function 355 is connected to the output of the processing module 338 over connection 354. In some embodiments, the MISR test function 355 may also be connected to the TPG 334 over logical connection 356.

In an exemplary embodiment, under certain circumstances and when in a test mode (i.e., when the control signal VBI is asserted), the TPG 334 is configured to generate test image data (e.g., a test frame) to inject into the processing module 336 during a portion of an image frame other than the portion of the image frame that is used for active data transfer. For example, the TPG 334 may generate test data for injection to the processing module 336 during a vertical blanking interval (VBI) of a video frame. In some embodiments, the test data may also be provided over connection 356 to the MISR test function 355 so that the MISR test function 355 has “verified” or “golden” test data to use to compare to test data after the test data generated by the TPG 334 is processed by the processing modules 336, 337 and 338. In an exemplary embodiment, the “verified MISR” or “golden MISR” value may be register-based where software configures (or programs) a “verified” or “golden MISR” value at the beginning of each video frame. Alternatively, the “verified MISR” or “golden MISR” value may be lookup table (LUT) based, where software configures (or programs) a set of all “verified MISR” or “golden MISR” values at the beginning of a camera session. Based on test frame sequence, hardware reads a corresponding “verified MISR” or “golden MISR” value from a LUT and compares it with the test frame computed MISR value. In an exemplary embodiment, the LUT may be located in the DDR memory 252 or in another memory. The MISR test function 355 will be described in greater detail below.

In an exemplary embodiment, the test SW REGs 312, 314 and 316 may be configured by the CPU 230 (FIG. 2) in a test mode to then configure the respective processing modules 336, 337 and 338 to process the test image data provided by the TPG 334 in the VBI of a video frame when the control signal, VBI, is asserted. In an exemplary embodiment, the control signal, VBI, may be used to select the TPG 334 input to the MUX 332 and may select the test SW REG inputs to the MUXs 324, 326 and 328 to allow the test SW REGs 312, 314 and 316 to configure the processing modules 336, 337 and 338, respectively, to process the test image data.

In an exemplary embodiment, the MISR test function 355 computes a MISR signature of the test frame and compares the computed MISR signature with the “verified” or “golden” MISR value to determine whether the processing modules 336, 337 and 338 are accurately processing the test image data sent in the VBI.

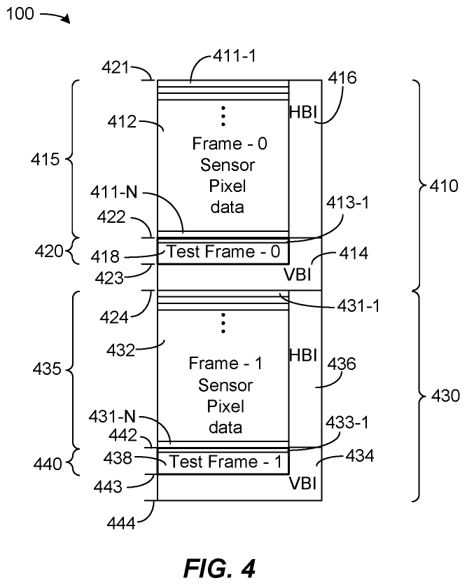

FIG. 4 is a diagram 400 showing video frames in accordance with an exemplary embodiment of the disclosure. In an exemplary embodiment, video frames 410 and 430 are shown in FIG. 4 for exemplary purposes only. Typically, a video stream comprises many more video frames. A first video frame 410 may comprise a data portion 415 and a test portion 420. In an exemplary embodiment, the data portion 415 may comprise an active region having a first data frame 412 (Frame-0). In an exemplary embodiment, the first video frame 410 comprises functional frame lines 411 in the first data frame 412. The entire first data frame 412 comprises functional frame lines 411-1 through 411-N, but only four lines are shown in FIG. 4 for ease of illustration.

In an exemplary embodiment, a vertical blanking interval (VBI) 414 may follow at the end of the data portion 415. The test portion 420 may occupy a part of the VBI 414. In an exemplary embodiment, the test portion 420 may include a first test frame 418 (Test Frame-0). In an exemplary embodiment, the first test frame 418 may include test frame lines, an exemplary one of which is shown using reference numeral 413-1. In an exemplary embodiment, the first video frame 410 also comprises a horizontal blanking interval (HBI) 416. In an exemplary embodiment, in general, the VBI 414 and the HBI 416 are portions of the first video frame 410 where no image data occurs.

In an exemplary embodiment, the first data frame 412 begins at a time 421 and extends to a time 422, at which time the first test frame 418 (Test Frame-0) begins. The first test frame 418 ends at a time 423 and the first video frame 410 ends at a time 424.

Similar to the first video frame 410, a second video frame 430 may comprise a data portion 435 and a test portion 440. In an exemplary embodiment, the data portion 435 may comprise an active region having a second data frame 432 (Frame-1). In an exemplary embodiment, the second video frame 430 comprises functional frame lines 431 in the second data frame 432. The entire second data frame 432 comprises functional frame lines 431-1 through 431-N, but only four lines are shown in FIG. 4 for ease of illustration.

In an exemplary embodiment, a vertical blanking interval (VBI) 434 may follow at the end of the data portion 435. The test portion 440 may occupy a part of the VBI 434. In an exemplary embodiment, the test portion 440 may include a second test frame 438 (Test Frame-1). In an exemplary embodiment, the second test frame 438 may include test frame lines, an exemplary one of which is shown using reference numeral 433-1. In an exemplary embodiment, the video frame 430 also comprises a horizontal blanking interval (HBI) 436. In an exemplary embodiment, in general, the VBI 434 and the HBI 436 are portions of the second video frame 430 where no image data occurs.

In an exemplary embodiment, the second data frame 432 begins at a time 424 and extends to a time 442, at which time the second test frame 438 (Test Frame-1) begins. The second test frame 438 ends at a time 443 and the second video frame 430 ends at a time 444.

In accordance with an exemplary embodiment, the number of test frames (with test frame 418 and test frame 438 being examples) sent in a test period may be varied based on a desired ASIL score. For example, a higher number of test frames sent in a given time generally equates to a higher ASIL score. In some embodiments, the number of test frames may be configurable and controlled by software configuration. A typical number of test frames may be the same as a typical number of data frames, such as, for example only, 30 frames per second (FPS). Other numbers of frames per second are possible and the number of test frames sent in a given time period is not necessarily the same as the number of data frames sent in a given time period.

In accordance with an exemplary embodiment, sending test frames 418 and 438 in the VBI can be accomplished with no increase in the total number of video frames per second (FPS), no increase in the clock rate of the IFE 310, and no impact to the bandwidth or power consumption of the DDR memory 352.

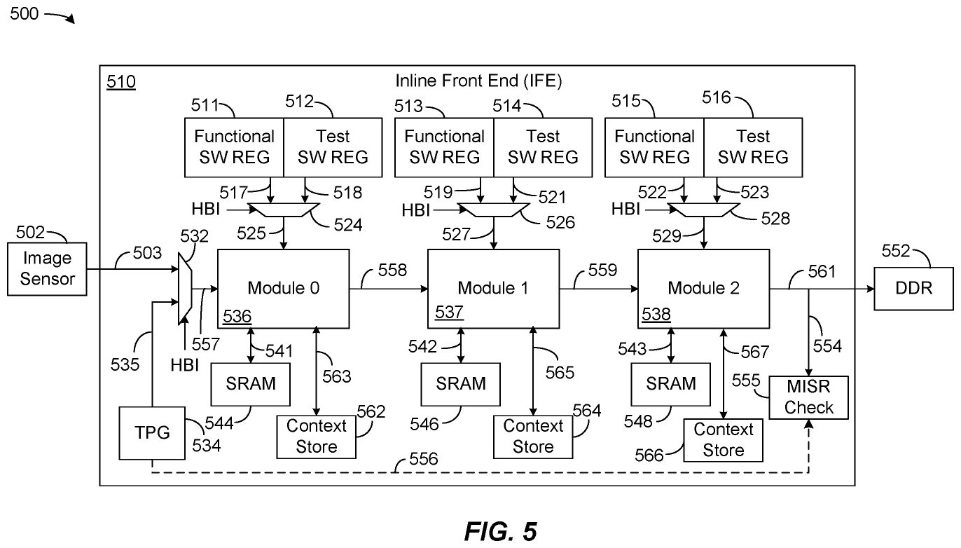

FIG. 5 is a block diagram 500 showing an in-line front end (IFE) 510 of FIG. 2 in accordance with an exemplary embodiment of the disclosure. The IFE 510 is similar to the IFE 310 of FIG. 3, but the IFE 510 uses the HBI to send test data instead of the VBI. Elements in FIG. 5 that are similar to corresponding elements in FIG. 3 are labeled labelled 5XX and are similar to elements labeled 3XX in FIG. 3.

In an exemplary embodiment, the IFE 510 may be configured to perform processing module testing using test frames sent during the horizontal blanking interval (HBI) of a video frame. In an exemplary embodiment, the IFE 510 may receive image data from an image sensor 502. Although a single image sensor 502 is shown in FIG. 5, the IFE 510 may receive image data from more than one image sensor.

In an exemplary embodiment, the IFE 510 comprises processing modules 536, 537 and 538. In an exemplary embodiment, each of the processing modules 536, 537 and 538 may be configured to perform different image processing tasks on the image data from the image sensor 502.

The IFE 510 also comprises a functional software (SW) register (REG) 511 connected to a multiplexer (MUX) 524 over connection 517 and a test SW REG 512 connected to the MUX 524 over connection 518. The MUX 524 is connected to the processing module 536 over connection 525. The MUX 524 is configured to receive a control signal, HBI, from the VBI/HBI detect module 251. In an exemplary embodiment, the HBI control signal may be generated by logic and/or software configured to detect the HBI period in an image stream this logic being shown in FIG. 2 as VBI/HBI detect module 251. For example, the HBI period may be detected based on the end of a current line to the start of a next line. In an exemplary embodiment, the VBI/HBI module 251 executing on the CPU 230 of FIG. 2 (or another processor) may detect the HBI period and can generate the HBI control signal when it is desired to configure the processing module 536 using the configuration provided by the test SW REG 512. When the control signal, HBI, is not asserted, the processing module 536 is configured by the functional SW REG 511.

The IFE 510 also comprises a functional SW REG 513 connected to a multiplexer (MUX) 526 over connection 519 and a test SW REG 514 connected to the MUX 526 over connection 521. The MUX 526 is connected to the processing module 537 over connection 527. The MUX 526 is configured to receive the control signal, HBI when it is desired to configure the processing module 537 using the configuration provided by the test SW REG 514. When the control signal, HBI, is not asserted, the processing module 537 is configured by the functional SW REG 513.

The IFE 510 also comprises a functional SW REG 515 connected to a multiplexer (MUX) 528 over connection 522 and a test SW REG 516 connected to the MUX 528 over connection 523. The MUX 528 is connected to the processing module 538 over connection 529. The MUX 528 is configured to receive the control signal, HBI when it is desired to configure the processing module 538 using the configuration provided by the test SW REG 516. When the control signal, HBI, is not asserted, the processing module 538 is configured by the functional SW REG 515.

In an exemplary embodiment, the processing module 536 is connected to a static random access memory (SRAM) 544 over connection 541; the processing module 537 is connected to a static random access memory (SRAM) 546 over connection 542; and the processing module 538 is connected to a static random access memory (SRAM) 548 over connection 543.

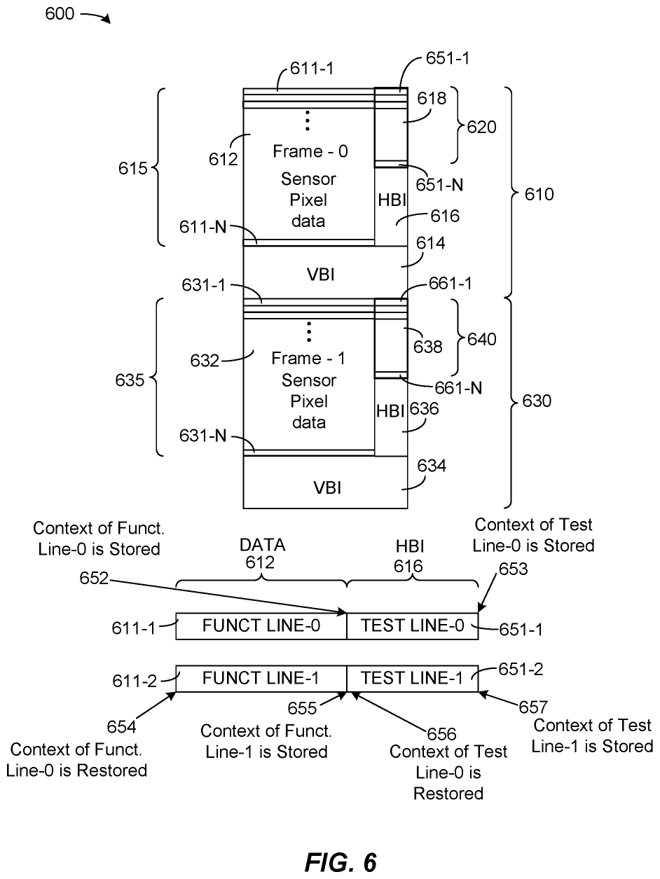

In an exemplary embodiment, the processing module 536 is connected to a context store element 562 over connection 563; the processing module 537 is connected to a context store element 564 over connection 565; and the processing module 538 is connected to a context store element 566 over connection 567. In an exemplary embodiment, the context store elements 562, 564 and 566 may comprise memory or register locations for storing the context of functional frame lines 611/631 (FIG. 6) and test frame lines 651/661 (FIG. 6) as described herein.

In an exemplary embodiment, image data (pixels) is provided from the image sensor 502 over connection 503 to a MUX 532. The MUX 532 is also connected to a test pattern generator (TPG) 534 over a connection 535. The MUX 532 is also configured to receive a control signal, HBI. When the control signal, HBI, is asserted, the MUX 532 provides an output of the TPG 534 to the processing module 536. When the control signal, HBI, is not asserted, the MUX 532 provides an output of the image sensor 502 to the processing module 536.

In an exemplary embodiment, when in a normal processing mode, image data is provided from the image sensor 502 over connection 503 to the MUX 532 and then over connection 557 to the processing module 536. The processing module 536 performs its image processing function and then provides its output over connection 558 to the processing module 537. The processing module 537 performs its image processing function and then provides its output over connection 559 to the processing module 538. The processing module 538 performs its image processing function and then provides its output over connection 561 to the DDR memory 552.

In an exemplary embodiment, a multiple input signature register (MISR) test function 555 is connected to the output of the processing module 538 over connection 554. In some embodiments, the MISR test function 555 may also be connected to the TPG 534 over logical connection 556.

In an exemplary embodiment, under certain circumstances and when in a test mode (i.e., when the control signal HBI is asserted), the TPG 534 is configured to generate test image data (e.g., a test frame) to inject into the processing module 536 during a portion of an image frame other than the portion of the image frame that is used for active data transfer. For example, the TPG 534 may generate test data for injection to the processing module 536 during a horizontal blanking interval (HBI) of a video frame.

In an exemplary embodiment, when using some or all of the HBI to inject test data to the processing module 536, a context of each line is stored. For example, the context store element 562 may store the context of lines being processed by the processing module 536, the context store element 564 may store the context of lines being processed by the processing module 537, and the context store element 566 may store the context of lines being processed by the processing module 538. Context storing will be described in greater detail herein.

In some embodiments, the test data may also be provided over connection 556 to the MISR test function 555 so that the MISR test function 555 has a “verified” or “golden” test data to use to compare to test data after the test data generated by the TPG 534 is processed by the processing modules 536, 537 and 538.

In an exemplary embodiment, the test SW REGs 512, 514 and 516 may be configured by the CPU 230 (FIG. 2) in a test mode to then configure the respective processing modules 536, 537 and 538 to process the test image data provided by the TPG 534 in the HBI of a video frame when the control signal, VBI, is asserted. In an exemplary embodiment, the control signal, HBI, may be used to select the TPG 534 input to the MUX 532 and may select the test SW REG inputs to the MUXs 524, 526 and 528 to allow the test SW REGs 512, 514 and 516 to configure the processing modules 536, 537 and 538, respectively, to process the test image data.

In an exemplary embodiment, the MISR test function 555 computes a MISR signature of the test frame and compares the computed MISR signature with a verified” or “golden” value to determine whether the processing modules 536, 337 and 338 are accurately processing the test image data sent in the HBI. The MISR test function 555 will be described in greater detail below.

FIG. 6 is a diagram 600 showing video frames in accordance with an exemplary embodiment of the disclosure. In an exemplary embodiment, video frames 610 and 630 are shown in FIG. 6 for exemplary purposes only. Typically, a video stream comprises many more video frames. In an exemplary embodiment, the video frames 610 and 630 are used to illustrate video frames when the HBI of a video frame is used to inject test data to the processing module 536 of FIG. 5.

A first video frame 610 may comprise a data portion 615 and a test portion 620. In an exemplary embodiment, the data portion 615 may comprise an active region having a first data frame 612 (Frame-0). In an exemplary embodiment, the first video frame 610 comprises functional frame lines 611 in the first data frame 612. The entire first data frame 612 comprises functional frame lines 611-1 through 611-N, but only four lines are shown in FIG. 6 for ease of illustration. In an exemplary embodiment, a vertical blanking interval (VBI) 614 may follow at the end of the data portion 615 and a horizontal blanking interval (HBI) 616 may follow the first data frame 612.

In an exemplary embodiment, the test portion 620 may occupy a part of the HBI 616. In an exemplary embodiment, the test portion 620 may include a first test frame 618 (Test Frame-0). In an exemplary embodiment, in general, the VBI 614 and the HBI 616 are portions of the first video frame 610 where no image data occurs.

In an exemplary embodiment, the first test frame 618 comprises test frame lines 651 in the first test frame 618. The entire first test frame 618 comprises test frame lines 651-1 through 651-N, but only four lines are shown in FIG. 6 for ease of illustration.

Similar to the first video frame 610, a second video frame 630 may comprise a data portion 635 and a test portion 640. In an exemplary embodiment, the data portion 635 may comprise an active region having a second data frame 632 (Frame-1). In an exemplary embodiment, the second video frame 630 comprises functional frame lines 631 in the second data frame 632. The entire second data frame 632 comprises functional frame lines 631-1 through 631-N, but only four lines are shown in FIG. 6 for ease of illustration. In an exemplary embodiment, a vertical blanking interval (VBI) 634 may follow at the end of the data portion 635 and a horizontal blanking interval (HBI) 636 may follow the first data frame 632.

In an exemplary embodiment, the test portion 640 may occupy a part of the HBI 636. In an exemplary embodiment, the test portion 640 may include a second test frame 638 (Test Frame-1). In an exemplary embodiment, in general, the VBI 634 and the HBI 636 are portions of the second video frame 630 where no image data occurs.

In an exemplary embodiment, the second test frame 638 comprises test frame lines 661 in the second test frame 638. The entire second test frame 638 may comprise test frame lines 661-1 through 661-N, but only four lines are shown in FIG. 6 for ease of illustration.

In an exemplary embodiment, test data is generated by the TPG 534 (FIG. 5) and injected into the processing module 536 (FIG. 5) during the HBI 616 and/or the HBI 636. For example, a first functional frame line 611-1 (Functional Line-0) may be followed by a first test frame line 651-1 (Test Line-0). In an exemplary embodiment, the first test frame line 651-1 occurs during the HBI 616. However, when using the HBI 616 to send test data, because the first test frame line 651-1 follows after the first functional frame line 611-1, the context of the first functional frame line 611-1 is stored by, for example, the context store element 562 (FIG. 5), at time 652. Similarly, at the end of the first test frame line 651-1 at time 653, the context of the first test frame line 651-1 is stored in, for example, the context store element 562 (FIG. 5).

In an exemplary embodiment, at time 654 a second functional frame lime 611-2 begins and the context of the first functional frame line 611-1 is restored. This maintains continuity of the functional frame lines 611-1 and 611-2 so that the context of the first functional frame line 611-1 stored at time 652 is restored at the beginning of the second functional frame line 611-2 at time 654. At time 655, the second functional frame line 611-2 concludes and the context of the second functional frame line 611-2 is stored, for example, in the context store element 562 (FIG. 5). Also at time 655, the context of the first test frame line 651-1 is restored and a second test frame line 651-2 is sent to the processing module 536 (FIG. 5). In this manner, continuity is maintained from the first test line 651-1 to the second test line 651-2. At time 657 the second test frame line 651-2 concludes and the context of the second test frame line 651-1 is stored in, for example, context store element 562 (FIG. 5). In this manner, the context of the functional frame lines 611 and the context of the test frame lines 651 is maintained when the HBI s used to send test data.

In accordance with an exemplary embodiment, the number of test frames (with test frame 618 and test frame 638 being examples) may be varied based on a desired ASIL score.

In accordance with an exemplary embodiment, sending test frames 618 and 638 in the HBI can be accomplished with no increase in the number of frames per second (FPS), no increase in the clock rate of the IFE 510, and no impact to the bandwidth or power consumption of the DDR memory 552.

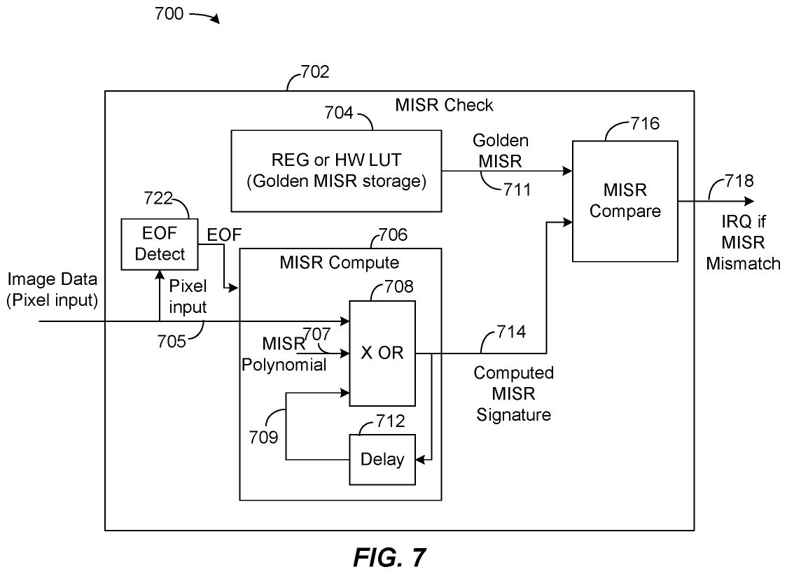

FIG. 7 is a diagram 700 showing the MISR test function of FIG. 3 and FIG. 5 in greater detail. In an exemplary embodiment, a MISR checker 702 may comprise a golden MISR storage 704, a MISR compute function 706, a MISR compare function 716 and an end of file (EOF) detection element 722. In an exemplary embodiment, the golden MISR storage 704 may comprise, for example, software registers or a hardware lookup table (LUT), depending on implementation. In an exemplary embodiment, the TPG 334 (FIG. 3) or the TPG 534 (FIG. 5) may be configured to generate a “verified” or “golden” MISR for storage in the golden MISR store 704 when a test pattern is generated.

In an exemplary embodiment, the MISR compute function 706 may comprise an exclusive OR (XOR) function 708 and a delay element 712. In an exemplary embodiment, image data in the form of a serial stream of pixel data may be provided over connection 705 to the XOR function 708. The image data on connection 705 may correspond to the output of the processing module 338 (FIG. 3) or the processing module 538 (FIG. 5). In an exemplary embodiment the EOF detection element 722 also receives the serial stream of pixel data over connection 705 and generates an end of file (EOF) indicator at the end of the data stream that may be provided to the MISR compute function 706 when the end of the stream of pixel data over connection 705 is reached.

A MISR polynomial may be provided to the XOR function 708 over connection 707. A MISR algorithm (not shown) may generate the MISR polynomial.

In an exemplary embodiment, a computed MISR signature of a current image frame may be provided as an output of the MISR compute function 706 on connection 714. The computed MISR signature output on connection 714 is also provided to the delay element 712, which provides a delayed version of the computed MISR signature over connection 709 to the XOR function 708. In an exemplary embodiment, the current MISR signature computed value on connection 714 is also used as input for the following MISR computation, so the current MISR signature is provided to the delay element 712 so it is available for the following MISR signature computation.

In an exemplary embodiment, the golden MISR is provided from the golden MISR storage 704 over connection 711 to the MISR compare function 716; and the computed MISR signature is also provided to the MISR compare function 716 over connection 714. The MISR compare function 716 compares the golden MISR with the computed MISR signature. If the golden MISR does not match the computed MISR signature, the MISR compare function 716 issues an interrupt request (IRQ) to the safety manager 238 (FIG. 2). In an exemplary embodiment, an IRQ may be issued because the test data that was processed through the IFE 310 (FIG. 3) or 510 (FIG. 5) and represented by the computed MISR signature does not match the original test data represented by the golden MISR value.

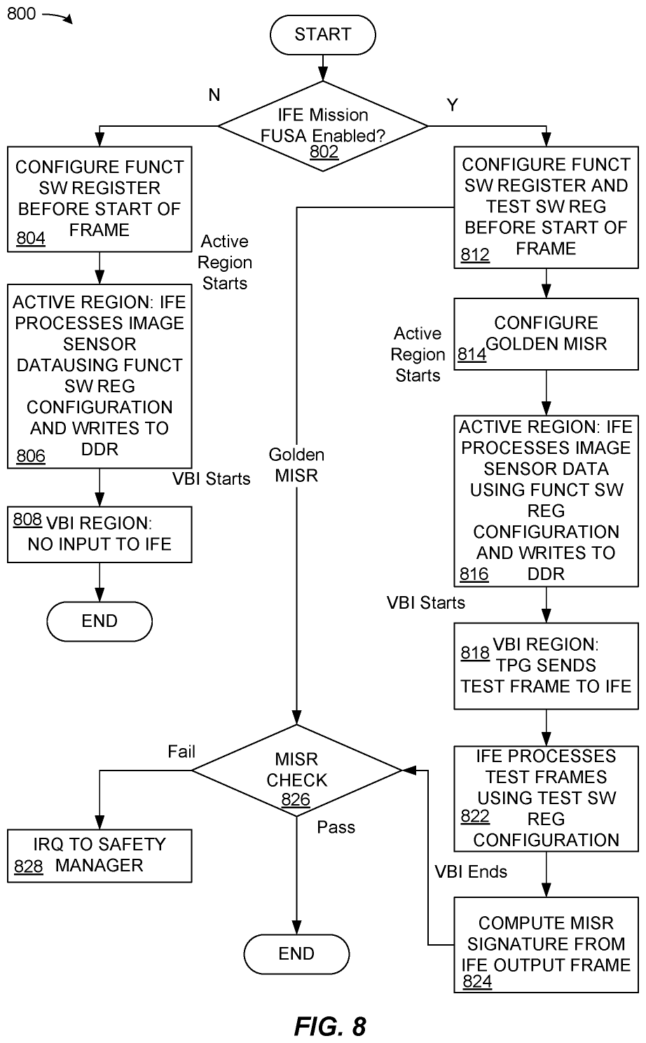

FIG. 8 is a flow chart 800 describing an example of the operation of a method for performing video system testing. The blocks in the method 800 can be performed in or out of the order shown, and in some embodiments, can be performed at least in part in parallel.

In block 802 it is determined whether the IFE is enabled for functional safety interrupt (e.g., a FUSA IRQ). In an exemplary embodiment, this determination may be made by the safety manager 238 (FIG. 2). If it is determined in block 802 that the IFE is not enabled for a FUSA IRQ, then in block 804, the functional software registers are configured for operation before the start of a video frame. For example, the functional software registers 311, 313 and 315 may be configured to allow the processing modules 336, 337 and 338, respectively, to process functional frames.

In block 806 in the active region, that is during a first data frame 412, the processing modules 336, 337 and 338 in the IFE 310 process image sensor data using the configuration provided by the functional software registers and write to the DDR memory 352.

In block 808 during a VBI region, there is no input to the IFE. For example, when test mode is not enabled, during a VBI 414 there is no input to the IFE 310.

If it is determined in block 802 that the IFE is enabled for a FUSA IRQ, then in block 812, the functional software registers and the test software registers are configured for operation before the start of a video frame. For example, the functional software registers 311, 313 and 315 may be configured to allow the processing modules 336, 337 and 338, respectively, to process functional frames and the test software registers 312, 314 and 316 may be configured to allow the processing modules 336, 337 and 338, respectively, to process test frames.

In block 814, a golden MISR may be configured. For example, the TPG 334 may generate test data and configure a “verified” or “golden” MISR value.

In block 816, in the active region, that is during a first data frame 412, the processing modules 336, 337 and 338 in the IFE 310 process image sensor data using the configuration provided by the functional software registers and write to the DDR memory 352.

In block 818 during a VBI region, the TPG 334 sends test data to the IFE 310. For example, when test mode is enabled, during a VBI 414 the TPG 334 generates test data, the control signal VBI is asserted and the test data is provided via the MUX 332 to the processing module 336.

In block 822, the IFE processes the test data using the configuration provided by the test software registers. For example, the processing modules 336, 336 and 338 in the IFE 310 process the test data generated by the TPG 334 using the configuration provided by the test software registers 312, 314 and 316. In an exemplary embodiment, in test mode the processed test data will be directed to the MISR test function 355 (FIG. 3) and will not be written to the DDR memory 352 (FIG. 3).

In block 824, a MISR signature is computed from the IFE output frame. For example, the MISR test function 355 computes a MISR signature from the output of the IFE 310 as described in FIG. 7.

In block 826, the MISR test function 355 determines whether the MISR signature computed in block 824 matches the golden MISR value.

If it is determined in block 826 that the computed MISR signature matches the golden MISR value, then the process ends. If it is determined in block 826 that the computed MISR signature does not match the golden MISR value, then in block 828 an interrupt request (IRQ) is sent to the safety manager. For example, an IRQ may be sent by the MISR compare function 716 (FIG. 7) to the safety manager 238 (FIG. 2).

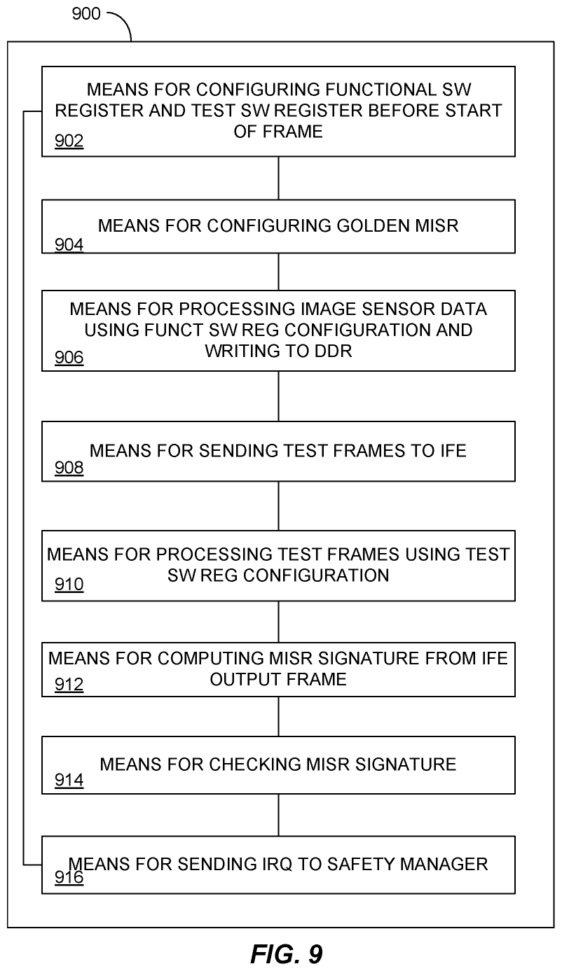

FIG. 9 is a functional block diagram of an apparatus 900 for performing video system testing. The apparatus 900 comprises means 902 for configuring the functional software registers and the test software registers for operation before the start of a video frame. In certain embodiments, the means 902 for configuring the functional software registers and the test software registers for operation before the start of a video frame can be configured to perform one or more of the functions described in operation block 812 of method 800 (FIG. 8). In an exemplary embodiment, the means 902 for configuring the functional software registers and the test software registers for operation before the start of a video frame may comprise the CPU 230 configuring the functional software registers 311, 313 and 315 for operation.

The apparatus 900 may also comprise means 904 for configuring a golden MISR. In certain embodiments, the means 904 for configuring a golden MISR can be configured to perform one or more of the functions described in operation block 814 of method 800 (FIG. 8). In an exemplary embodiment, the means 904 for configuring a golden MISR may comprise the TPG 334 generating test data and configuring a “verified” or “golden” MISR value.

The apparatus 900 may also comprise means 906 for processing image sensor data using the configuration provided by the functional software registers and writing to the DDR. In certain embodiments, the means 906 for processing image sensor data using the configuration provided by the functional software registers and writing to the DDR can be configured to perform one or more of the functions described in operation block 816 of method 800 (FIG. 8). In an exemplary embodiment, the means 906 for processing image sensor data using the configuration provided by the functional software registers and writing to the DDR may comprise during a first data frame 412, the processing modules 336, 337 and 338 in the IFE 310 processing image sensor data using the configuration provided by the functional software registers and writing to the DDR 352.

The apparatus 900 may also comprise means 908 for sending test frames to the IFE. In certain embodiments, the means 908 for sending test frames to the IFE can be configured to perform one or more of the functions described in operation block 818 of method 800 (FIG. 8). In an exemplary embodiment, the means 908 for sending test frames to the IFE may comprise, when test mode is enabled, during a VBI 414 the TPG 334 generating test data, the control signal VBI being asserted and the test data is provided via the MUX 332 to the processing module 336.

The apparatus 900 may also comprise means 910 for processing the test frames using the configuration provided by the test software registers. In certain embodiments, the means 910 for processing the test frames using the configuration provided by the test software registers can be configured to perform one or more of the functions described in operation block 822 of method 800 (FIG. 8). In an exemplary embodiment, the means 910 for processing the test frames using the configuration provided by the test software registers may comprise the processing modules 336, 336 and 338 in the IFE 310 processing the test data generated by the TPG 334 using the configuration provided by the test SW REGs 312, 314 and 316.

The apparatus 900 may also comprise means 912 for computing a MISR signature from the IFE output frame. In certain embodiments, the means 912 for computing a MISR signature from the IFE output frame can be configured to perform one or more of the functions described in operation block 824 of method 800 (FIG. 8). In an exemplary embodiment, the means 912 for computing a MISR signature from the IFE output frame may comprise the MISR test function 355 computing a MISR signature from the IFE output.

The apparatus 900 may also comprise means 914 for checking the MISR signature. In certain embodiments, the means 914 for checking the MISR signature can be configured to perform one or more of the functions described in operation block 826 of method 800 (FIG. 8). In an exemplary embodiment, the means 914 for checking the MISR signature may comprise the MISR test function 355 determining whether the computed MISR signature matches the golden MISR value.

The apparatus 900 may also comprise means 916 for sending an IRQ to the safety manager. In certain embodiments, the means 916 for sending an IRQ to the safety manager can be configured to perform one or more of the functions described in operation block 828 of method 800 (FIG. 8). In an exemplary embodiment, the means 916 for sending an IRQ to the safety manager may comprise the MISR compare function 716 (FIG. 7) sending an IRQ to the safety manager 238 (FIG. 2).

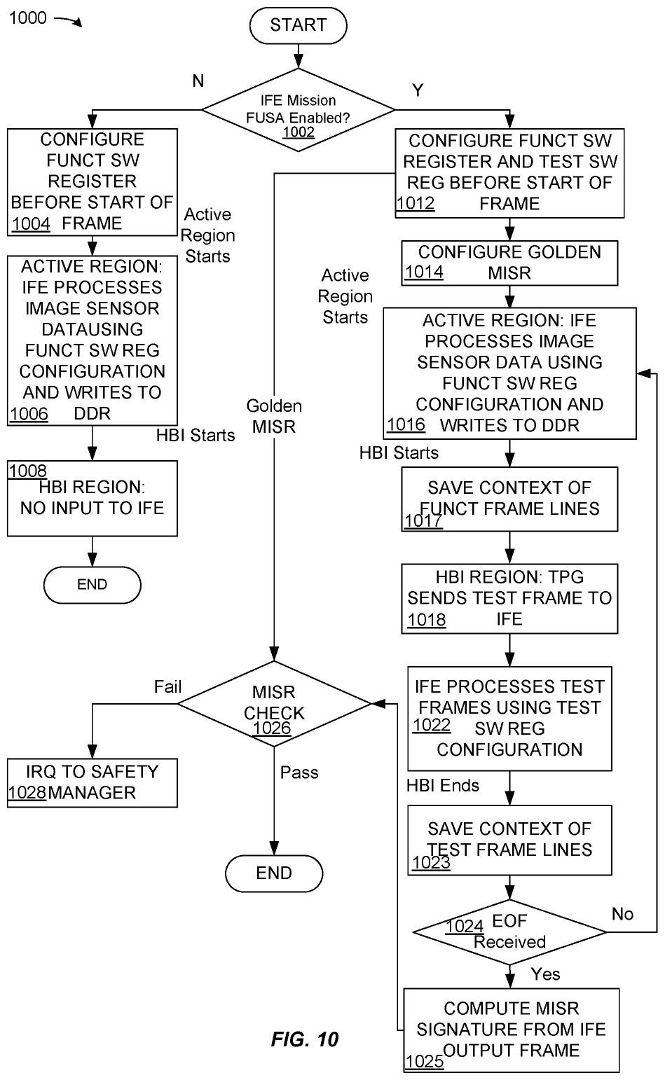

FIG. 10 is a flow chart 1000 describing an example of the operation of a method for performing video system testing. The blocks in the method 1000 can be performed in or out of the order shown, and in some embodiments, can be performed at least in part in parallel. The method 1000 is similar to the method 800 described in FIG. 8. However, the method 1000 described in FIG. 10 uses the horizontal blanking interval (HBI) to send test data.

In block 1002 it is determined whether the IFE is enabled for functional safety interrupt (e.g., a FUSA IRQ). In an exemplary embodiment, this determination may be made by the safety manager 238 (FIG. 2). If it is determined in block 1002 that the IFE is not enabled for a FUSA IRQ, then in block 1004, the functional software registers are configured for operation before the start of a video frame. For example, the functional software registers 511, 513 and 515 may be configured to allow the processing modules 536, 537 and 538, respectively, to process functional frames.

In block 1006 in the active region, that is during a first data frame 612, the processing modules 536, 537 and 538 in the IFE 510 process image sensor data using the configuration provided by the functional software registers and write to the DDR memory 552.

In block 1008 during an HBI region, there is no input to the IFE. For example, when test mode is not enabled, during an HBI 616 there is no input to the IFE 510.

If it is determined in block 1002 that the IFE is enabled for a FUSA IRQ, then in block 1012, the functional software registers and the test software registers are configured for operation before the start of a video frame. For example, the functional software registers 511, 513 and 515 may be configured to allow the processing modules 536, 537 and 538, respectively, to process functional frames and the test software registers 512, 514 and 516 may be configured to allow the processing modules 536, 537 and 538, respectively, to process test frames.

In block 1014, a golden MISR may be configured. For example, the TPG 534 may generate test data and configure a “verified” or “golden” MISR value.

In block 1016, in the active region, that is during a first data frame 612, the processing modules 536, 537 and 538 in the IFE 510 process image sensor data using the configuration provided by the functional software registers and write to the DDR memory 552.

In block 1017, the context of functional frame lines is saved. For example, while test data is being sent to the processing modules 536, 537 and 538, the context store elements 562, 564 and 566, respectively, store and restore the context of functional frame lines 611/631.

In block 1018 during an HBI region, the TPG 534 sends test frames to the IFE 510. For example, when test mode is enabled, during an HBI 616 the TPG 534 generates test data, the control signal HBI is asserted and the test data is provided via the MUX 532 to the processing module 536.

In block 1022, the IFE processes the test frames using the configuration provided by the test software registers. For example, the processing modules 536, 536 and 538 in the IFE 510 process the test data generated by the TPG 534 using the configuration provided by the test software registers 512, 514 and 516.

In block 1023, the context of test frame lines is saved. For example, while test data is being sent to the processing modules 536, 537 and 538, the context store elements 562, 564 and 566, respectively, store and restore the context of test frame lines 651/661.

In block 1024, it is determined whether an end of frame (EOF) indicator is received. For example, the EOF detect element 722 (FIG. 7) may detect the end of a frame and send an EOF indicator signal to the MISR compute function 706. If an EOF indicator is not received, the process returns to block 1016. If an EOF indicator is received in block 1024, the process proceeds to block 1025.

In block 1025, a MISR signature is computed from the IFE output frame. For example, the MISR test function 555 computes a MISR signature from the output of the IFE 510 as described in FIG. 7.

In block 1026, the MISR test function 555 determines whether the MISR signature computed in block 1025 matches the golden MISR signature computed in block 1025.

If it is determined in block 1026 that the computed MISR signature matches the golden MISR value, then the process ends. If it is determined in block 1026 that the computed MISR signature does not match the golden MISR value, then in block 1028 an interrupt request (IRQ) is sent to the safety manager. For example, an IRQ may be sent by the MISR compare function 716 (FIG. 7) to the safety manager 238 (FIG. 2).

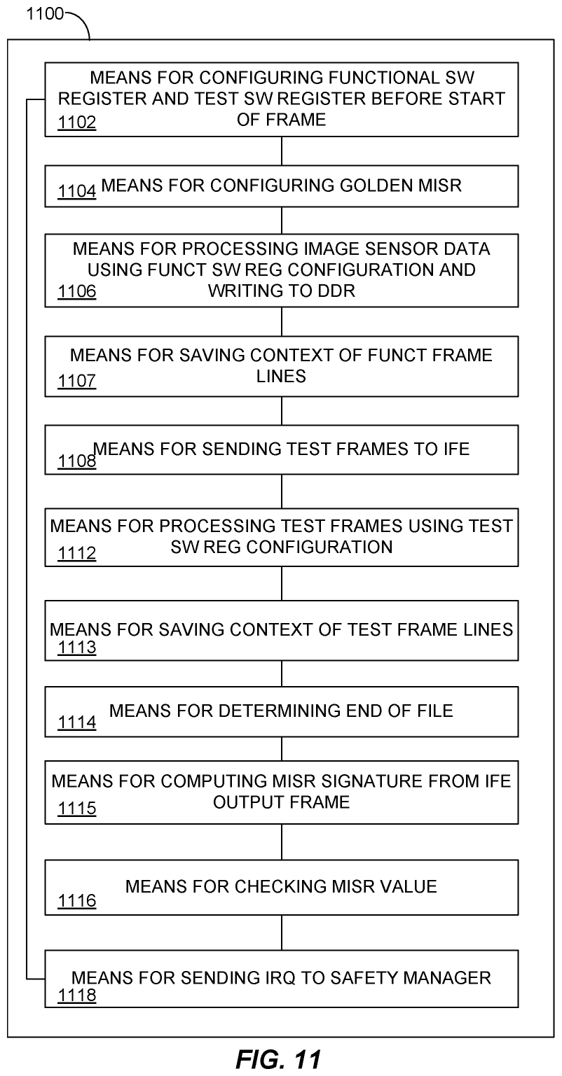

FIG. 11 is a functional block diagram of an apparatus 1100 for performing video system testing. The apparatus 1100 comprises means 1102 for configuring the functional software registers and the test software registers for operation before the start of a video frame. In certain embodiments, the means 1102 for configuring the functional software registers and the test software registers for operation before the start of a video frame can be configured to perform one or more of the functions described in operation block 1012 of method 1000 (FIG. 10). In an exemplary embodiment, the means 1102 for configuring the functional software registers and the test software registers for operation before the start of a video frame may comprise the CPU 230 configuring the functional software registers 511, 513 and 515 for operation.

The apparatus 1100 may also comprise means 1104 for configuring a golden MISR. In certain embodiments, the means 1104 for configuring a golden MISR can be configured to perform one or more of the functions described in operation block 1014 of method 1000 (FIG. 10). In an exemplary embodiment, the means 1104 for configuring a golden MISR may comprise the TPG 534 generating test data and configuring a “verified” or “golden” MISR value.

The apparatus 1100 may also comprise means 1106 for processing image sensor data using the configuration provided by the functional software registers and writing to the DDR. In certain embodiments, the means 1106 for processing image sensor data using the configuration provided by the functional software registers and writing to the DDR can be configured to perform one or more of the functions described in operation block 1016 of method 1000 (FIG. 10). In an exemplary embodiment, the means 1106 for processing image sensor data using the configuration provided by the functional software registers and writing to the DDR may comprise during a first data frame 612, the processing modules 536, 537 and 538 in the IFE 510 processing image sensor data using the configuration provided by the functional software registers and writing to the DDR memory 552.

The apparatus 1100 may also comprise means 1107 for saving context of functional frame lines. In certain embodiments, the means 1107 for saving context of functional frame lines can be configured to perform one or more of the functions described in operation block 1017 of method 1000 (FIG. 10). In an exemplary embodiment, the means 1107 for saving context of functional frame lines may comprise, while test data is being sent to the processing modules 536, 537 and 538, the context store elements 562, 564 and 566, respectively, storing and restoring the context of functional frame lines 611/631.

The apparatus 1100 may also comprise means 1108 for sending test frames to the IFE. In certain embodiments, the means 1108 for sending test frames to the IFE can be configured to perform one or more of the functions described in operation block 1018 of method 1000 (FIG. 10). In an exemplary embodiment, the means 1108 for sending test frames to the IFE may comprise, when test mode is enabled, during an HBI 616 the TPG 534 generating test data, the control signal HBI being asserted and the test data is provided via the MUX 532 to the processing module 536.

The apparatus 1100 may also comprise means 1112 for processing the test frames using the configuration provided by the test software registers. In certain embodiments, the means 1112 for processing the test frames using the configuration provided by the test software registers can be configured to perform one or more of the functions described in operation block 1022 of method 1000 (FIG. 10). In an exemplary embodiment, the means 1112 for processing the test frames using the configuration provided by the test software registers may comprise the processing modules 536, 536 and 538 in the IFE 510 processing the test data generated by the TPG 534 using the configuration provided by the test software registers 512, 514 and 516.

The apparatus 1100 may also comprise means 1113 for saving context of test frame lines. In certain embodiments, the means 1113 for saving context of test frame lines can be configured to perform one or more of the functions described in operation block 1023 of method 1000 (FIG. 10). In an exemplary embodiment, the means 1113 for saving context of test frame lines may comprise, while test data is being sent to the processing modules 536, 537 and 538, the context store elements 562, 564 and 566, respectively, storing and restoring the context of test frame lines 651/661.

The apparatus 1100 may also comprise means 1114 for determining an end of file. In certain embodiments, the means 1114 for determining an end of file can be configured to perform one or more of the functions described in operation block 1024 of method 1000 (FIG. 10). In an exemplary embodiment, the means 1114 for determining an end of file may comprise, the EOF detect element 722 (FIG. 7) detecting the end of a frame and sending an EOF indicator signal to the MISR compute function 706.

The apparatus 1100 may also comprise means 1115 for computing a MISR signature from the IFE output frame. In certain embodiments, the means 1115 for computing a MISR signature from the IFE output frame can be configured to perform one or more of the functions described in operation block 1025 of method 1000 (FIG. 10). In an exemplary embodiment, the means 1115 for computing a MISR signature from the IFE output frame may comprise the MISR test function 555 computing a MISR signature from the IFE output.

The apparatus 1100 may also comprise means 1116 for checking the MISR signature. In certain embodiments, the means 1116 for checking the MISR signature can be configured to perform one or more of the functions described in operation block 1026 of method 1000 (FIG. 810). In an exemplary embodiment, the means 1116 for checking the MISR signature may comprise the MISR test function 555 determining whether the computed MISR signature matches the golden MISR value.

The apparatus 1100 may also comprise means 1118 for sending an IRQ to the safety manager. In certain embodiments, the means 1118 for sending an IRQ to the safety manager can be configured to perform one or more of the functions described in operation block 1028 of method 1000 (FIG. 10). In an exemplary embodiment, the means 1118 for sending an IRQ to the safety manager may comprise the MISR compare function 716 (FIG. 7) sending an IRQ to the safety manager 238 (FIG. 2).

Implementation examples are described in the following numbered clauses:

1. An image processing system comprising: an image sensor configured to generate a video frame, the video frame having a data portion and a test portion; an inline front end (IFE) having at least one processing module, a first memory, a functional software register, and a test software register, the IFE configured to receive the video frame, process the video frame and store the processed video frame to a second memory; a test pattern generator configured to generate test data that is provided to the IFE during the test portion of the video frame; a multiple input signature register (MISR) test function configured to compute a MISR signature from the test data; and a comparison function configured to compare a verified version of the test data to the computed MISR signature in the IFE to determine whether a system interrupt should be generated.

2. The image processing system of clause 1, wherein the test portion comprises a vertical blanking interval (VBI) of a video frame.

3. The image processing system of clause 1, wherein the test portion comprises a horizontal blanking interval (HBI) of a video frame.

4. The image processing system of clause 2, wherein the test data is sent in test frame lines in the VBI.

5. The image processing system of clause 3, wherein the data portion is sent in functional frame lines and the test data is sent in test frame lines in the HBI.

6. The image processing system of clause 5, further comprising a context storage configured to store a context of the functional frame lines and a context of the test frame lines.

7. The image processing system of any of clauses 5 through 6, wherein the context of a first functional frame line is stored at the beginning of a first test frame line, and the stored context of the first functional frame line is restored at the beginning of a second functional frame line.

8. The image processing system of any of clauses 5 through 7, wherein the context of a first test frame line is stored at the beginning of a second functional frame line, and the stored context of the first test frame line is restored at the beginning of a second test frame line.

9. The image processing system of any of clauses 1 through 8, wherein the test data is sent in test frames and a number of test frames may be varied based on a desired automobile safety integrity level (ASIL) score.

10. A method for testing an image processing system comprising: configuring a test software register prior to the start of a video frame; generating test image data; generating a verified multiple input signature register (MISR) value corresponding to the test image data; injecting the test data to the IFE during a blanking interval of the video frame; processing the test data to generate a test output; computing a MISR signature associated with the test output; and comparing the computed MISR signature to the verified MISR value to determine whether the test data matches the generated test output.

11. The method of clause 10, wherein the blanking interval comprises a vertical blanking interval (VBI) of the image frame.

12. The method of clause 10, wherein the blanking interval comprises a horizontal blanking interval (HBI) of the image frame.

13. The method of clause 11, further comprising sending the test data in test frame lines in the VBI.

14. The method of clause 12, further comprising: sending the data portion in functional frame lines in the HBI; and sending the test data in test frame lines in the HBI.

15. The method of clause 14, further comprising: storing a context of the functional frame lines; and storing a context of the test frame lines.

16. The method of any of clauses 14 through 15, further comprising: storing the context of a first functional frame line at the beginning of a first test frame line; and restoring the stored context of the first functional frame line at the beginning of a second functional frame line.

17. The method of any of clauses 14 through 16, further comprising: storing the context of a first test frame line at the beginning of a second functional frame line; and restoring the stored context of the first test frame line at the beginning of a second test frame line.

18. The method of any of clauses 10 through 17, wherein the test data is sent in test frames and a number of test frames may be varied based on a desired automobile safety integrity level (ASIL) score.

19. A device for testing an image processing system comprising: means for configuring a test software register prior to the start of a video frame; means for generating test image data; means for generating a verified multiple input signature register (MISR) value corresponding to the test image data; means for injecting the test data to the IFE during a blanking interval of the video frame; means for processing the test data to generate a test output; means for computing a MISR signature associated with the test output; and means for comparing the computed MISR signature to the verified MISR value to determine whether the test data matches the generated test output.

20. The device of clause 19, wherein the blanking interval comprises a vertical blanking interval (VBI) of the image frame.

21. The device of clause 19, wherein the blanking interval comprises a horizontal blanking interval (HBI) of the image frame.

22. The device of clause 20, further comprising sending the test data in test frame lines in the VBI.

23. The device of clause 21, further comprising: means for sending the data portion in functional frame lines in the HBI; and means for sending the test data in test frame lines in the HBI.

24. The device of clause 23, further comprising: means for storing a context of the functional frame lines; and means for storing a context of the test frame lines.

25. The device of any of clauses 23 through 24, further comprising: means for storing the context of a first functional frame line at the beginning of a first test frame line; and means for restoring the stored context of the first functional frame line at the beginning of a second functional frame line.

26. The device of any of clauses 23 through 25, further comprising: means for storing the context of a first test frame line at the beginning of a second functional frame line; and means for restoring the stored context of the first test frame line at the beginning of a second test frame line.

27. The device of any of clauses 19 through 26, wherein the test data is sent in test frames and a number of test frames may be varied based on a desired automobile safety integrity level (ASIL) score.

28. A non-transitory computer-readable medium comprising computer instructions for execution by a processor, the computer instructions comprising: computer instructions executable by the processor for configuring a test software register prior to the start of a video frame; computer instructions executable by the processor for generating test image data; computer instructions executable by the processor for generating a verified multiple input signature register (MISR) value corresponding to the test image data; computer instructions executable by the processor for injecting the test data to the IFE during a blanking interval of the video frame; computer instructions executable by the processor for processing the test data to generate a test output; computer instructions executable by the processor for computing a MISR signature associated with the test output; and computer instructions executable by the processor for comparing the computed MISR signature to the verified MISR value to determine whether the test data matches the generated test output.

29. The non-transitory computer-readable medium comprising computer instructions for execution by a processor of clause 28, wherein the blanking interval comprises a vertical blanking interval (VBI) of the image frame.

30. The non-transitory computer-readable medium comprising computer instructions for execution by a processor of clause 28, wherein the blanking interval comprises a horizontal blanking interval (HBI) of the image frame.

The circuit architecture described herein described herein may be implemented on one or more ICs, analog ICs, RFICs, mixed-signal ICs, ASICs, printed circuit boards (PCBs), electronic devices, etc. The circuit architecture described herein may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the circuit described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

Although selected aspects have been illustrated and described in detail, it will be understood that various substitutions and alterations may be made therein without departing from the spirit and scope of the present invention, as defined by the following claims.

What is claimed is:

1. An image processing system comprising:
an image sensor configured to generate a video frame, the video frame having a data portion and a test portion;
an inline front end (IFE) having at least one processing module, a first memory, a functional software register, and a test software register, the IFE configured to receive the video frame, process the video frame and store the processed video frame to a second memory;
a test pattern generator configured to generate test data that is provided to the IFE during the test portion of the video frame;
a multiple input signature register (MISR) test function configured to compute a MISR signature from the test data; and
a comparison function configured to compare a verified version of the test data to the computed MISR signature in the IFE to determine whether a system interrupt should be generated.

2. The image processing system of claim 1, wherein the test portion comprises a vertical blanking interval (VBI) of a video frame.

3. The image processing system of claim 1, wherein the test portion comprises a horizontal blanking interval (HBI) of a video frame.

4. The image processing system of claim 2, wherein the test data is sent in test frame lines in the VBI.

5. The image processing system of claim 3, wherein the data portion is sent in functional frame lines and the test data is sent in test frame lines in the HBI.

6. The image processing system of claim 5, further comprising a context storage configured to store a context of the functional frame lines and a context of the test frame lines.

7. The image processing system of claim 6, wherein the context of a first functional frame line is stored at the beginning of a first test frame line, and the stored context of the first functional frame line is restored at the beginning of a second functional frame line.

8. The image processing system of claim 6, wherein the context of a first test frame line is stored at the beginning of a second functional frame line, and the stored context of the first test frame line is restored at the beginning of a second test frame line.

9. The image processing system of claim 1, wherein the test data is sent in test frames and a number of test frames may be varied based on a desired automobile safety integrity level (ASIL) score.

10. A method for testing an image processing system comprising:
configuring a test software register prior to the start of a video frame;
generating test image data;
generating a verified multiple input signature register (MISR) value corresponding to the test image data;
injecting the test data to the IFE during a blanking interval of the video frame;
processing the test data to generate a test output;
computing a MISR signature associated with the test output; and
comparing the computed MISR signature to the verified MISR value to determine whether the test data matches the generated test output.

11. The method of claim 10, wherein the blanking interval comprises a vertical blanking interval (VBI) of the image frame.

12. The method of claim 10, wherein the blanking interval comprises a horizontal blanking interval (HBI) of the image frame.

13. The method of claim 11, further comprising sending the test data in test frame lines in the VBI.

14. The method of claim 12, further comprising:
sending the data portion in functional frame lines in the HBI; and
sending the test data in test frame lines in the HBI.

15. The method of claim 14, further comprising:
storing a context of the functional frame lines; and
storing a context of the test frame lines.

16. The method of claim 15, further comprising:
storing the context of a first functional frame line at the beginning of a first test frame line; and
restoring the stored context of the first functional frame line at the beginning of a second functional frame line.

17. The method of claim 15, further comprising:
storing the context of a first test frame line at the beginning of a second functional frame line; and
restoring the stored context of the first test frame line at the beginning of a second test frame line.

18. The method of claim 10, wherein the test data is sent in test frames and a number of test frames may be varied based on a desired automobile safety integrity level (ASIL) score.

19. A device for testing an image processing system comprising:
means for configuring a test software register prior to the start of a video frame;
means for generating test image data;
means for generating a verified multiple input signature register (MISR) value corresponding to the test image data;
means for injecting the test data to the IFE during a blanking interval of the video frame;
means for processing the test data to generate a test output;
means for computing a MISR signature associated with the test output; and
means for comparing the computed MISR signature to the verified MISR value to determine whether the test data matches the generated test output.

20. The device of claim 19, wherein the blanking interval comprises a vertical blanking interval (VBI) of the image frame.

21. The device of claim 19, wherein the blanking interval comprises a horizontal blanking interval (HBI) of the image frame.

22. The device of claim 20, further comprising sending the test data in test frame lines in the VBI.

23. The device of claim 21, further comprising:
means for sending the data portion in functional frame lines in the HBI; and
means for sending the test data in test frame lines in the HBI.

24. The device of claim 23, further comprising:
means for storing a context of the functional frame lines; and
means for storing a context of the test frame lines.

25. The device of claim 23, further comprising:
means for storing the context of a first functional frame line at the beginning of a first test frame line; and
means for restoring the stored context of the first functional frame line at the beginning of a second functional frame line.

26. The device of claim 23, further comprising:
means for storing the context of a first test frame line at the beginning of a second functional frame line; and
means for restoring the stored context of the first test frame line at the beginning of a second test frame line.

27. The device of claim 19, wherein the test data is sent in test frames and a number of test frames may be varied based on a desired automobile safety integrity level (ASIL) score.

28. A non-transitory computer-readable medium comprising computer instructions for execution by a processor, the computer instructions comprising:
computer instructions executable by the processor for configuring a test software register prior to the start of a video frame;
computer instructions executable by the processor for generating test image data;
computer instructions executable by the processor for generating a verified multiple input signature register (MISR) value corresponding to the test image data;
computer instructions executable by the processor for injecting the test data to the IFE during a blanking interval of the video frame;
computer instructions executable by the processor for processing the test data to generate a test output;
computer instructions executable by the processor for computing a MISR signature associated with the test output; and
computer instructions executable by the processor for comparing the computed MISR signature to the verified MISR value to determine whether the test data matches the generated test output.

29. The non-transitory computer-readable medium comprising computer instructions for execution by a processor of claim 28, wherein the blanking interval comprises a vertical blanking interval (VBI) of the image frame.

30. The non-transitory computer-readable medium comprising computer instructions for execution by a processor of claim 28, wherein the blanking interval comprises a horizontal blanking interval (HBI) of the image frame.
